(19) United States
(12) Patent Application Publication
(10) Pub. No.: US 2004/0249656 A1
(43) Pub. Date: Dec. 9, 2004

(54) Stakeholder framework

(76) Inventors: Sven Schwerin-Wenzel, Dielheim (DE); Eric Wood, Menlo Oaks, CA (US); Nir Kol, Sunnyvale, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/768,404

(22) Filed: Jan. 30, 2004

Related U.S. Application Data
(60) Provisional application No. 60/455,087, filed on Mar. 14, 2003.

(51) Int. Cl. G06F 17/60

(52) U.S. Cl. 705/1

(57) ABSTRACT

Systems and techniques relating to software for enterprise change, in particular to merger and acquisition processes and tools for one or more organizations. A system for planning a restructuring of at least two organizations includes an intranet interface adapted for at least one employee of one of the organizations, an extranet interface adapted for an external restructuring member of at least one of the organizations, and an information repository related to at least one of the organizations, the information repository being accessible by the intranet interface.

### CROSS REFERENCE TO RELATED APPLICATIONS

This application claims the benefit of priority from U.S. Provisional Application entitled “ENTERPRISE CHANGE PLANNING AND EXECUTION,” filed Mar. 14, 2003, application Ser. No. 60/455,087.

### BACKGROUND

During a restructuring such as a merger and/or acquisition, enterprises undergo many changes. If executed effectively, these changes help an enterprise to achieve one or more goals. To realize those goals in a restructuring environment, members associated with the enterprise changes can be involved in interactive decisions and discussions. Consequently, an enterprise may want to carefully plan and manage parts of one or more organizations or members during the restructuring process.

### SUMMARY

The present application describes systems, methods and software for restructuring, such as mergers & acquisitions (M&As), for one or more organizations.

In an aspect, the invention features a method of facilitating an enterprise change including treating two or more information systems as a single logical information system to execute pre-change due diligence and post-change integration of the enterprise change, the enterprise change being at least one of a merger and acquisition, and providing a user interface to allow a user to conduct a merger activity.

In embodiments, the user interface can be adapted to allow a stakeholder plan and manage the merger activity, the user interface further adapted to allow a user to access one or more merger resources.

In another aspect, the invention features a method including providing a single logical physically distributed information system across one or more information systems of at least two enterprises that are being combined, and providing a user interface to access the single logical physically distributed information system, wherein the single logical physically distributed information system executes one or more pre-merger activities, merger activities, and post-merger activities.

In embodiments, the user interface can be adapted to at least one of a role of the user and a phase of the merger, wherein the user role can include an internal expert and an external expert of one of the enterprises, wherein the internal expert can include at least one of an executive, an employee, a manager, an investor, and an owner of one of the enterprises, wherein the external expert can include at least one of a consultant and an auditor. The role of the user further can include a stakeholder affected with one or more merger closing consequences, wherein the one or more merger activities can include an organizational restructuring, a personnel redeployment, a merger project management, a procurement management, a personnel retainment, and an integration of operational services.

In another aspect, the invention features a system for planning a restructuring of at least two organizations including an intranet interface adapted for at least one employee of one of the organizations, an extranet interface adapted for an external restructuring member of at least one of the organizations, and an information repository related to at least one of the organizations, the information repository being accessible by the intranet interface.

In embodiments, the extranet interface can include a password interface, wherein the system further can include a firewall between the intranet interface and extranet interface.

In another aspect, the invention features a system for implementing a restructuring of at least two organizations, wherein the system can include an object modeling tool, a repository, a template, and an interface for a user to edit information for one or more personnel of at least one of the organizations.

In embodiments, the repository can include metadata.

In another aspect, the invention features a system for implementing a restructuring of at least two organizations including a tool adapted to track one or more stakeholders, a module adapted to identify one or more stakeholders, and a tool interface adapted to allow a stakeholder to access, plan, and manage pre-deal research.

In embodiments, the system can include a user interface adapted to allow collaboration with the one or more stakeholders, the collaboration including an arrangement of a meeting and an initiation of a discussion thread.

In another aspect, the invention features a system for implementing a merger of at least two organizations including a stakeholder interface, the stakeholder interface including a first panel adapted to allow a user to navigate among a user interfaces related to the merger, a second panel displaying one or more members of one or more groups of the organizations, and a search query interface adapted to allow a user to search for information related to the merger.

In embodiments, the system can include a menu adapted to receive a user selection, wherein the stakeholder interface can be adapted to allow an interactive discussion among merger members. The stakeholder interface further can include a menu for disparate interfaces, the disparate interfaces including a communication interface, an information sessions interface, and an organizational directory, the stakeholder interface further including a personalized merger task interface, a merger event interface, and an interface to a calendar.

The system can include one or more tools presenting a stakeholder with at least any one of a personalized object, a preferred object, a recently accessed object, and a merger-related object.

In another aspect, the invention features A system including a layer of merger application logic services for the merger of at least two organizations, information repositories for the merger, and user interfaces adapted to retrieve information from the information repositories, the user interfaces adapted to interact with the layer of merger application logic services.

In another aspect, the invention features a system for planning a merger of at least two organizations including an intranet template adapted for at least one stakeholder of at least one of the organizations.

In embodiments, the intranet template can include a reference model, the reference model including objects, folders, security settings, and reports.

In another aspect, the invention features a system adapted to execute management actions for a merger of at least two organizations, the system including a user-selectable portfolio of organizational information for planning, reporting, and analyzing merger information on a graphical user interface.

In embodiments, the system can include a definition tool, wherein the definition tool can be an integrated system tool.

### BRIEF DESCRIPTION OF THE DRAWINGS

These and other aspects will now be described in detail with reference to the following drawings.

FIG. 1 is a block diagram of an exemplary system.

FIG. 2 is a flow diagram of a restructuring integration process.

FIG. 3 is a block diagram of architecture.

FIG. 4 is a block diagram of a platform.

FIGS. 5-26 are exemplary user interfaces.

Like reference symbols in the various drawings indicate like elements.

### DETAILED DESCRIPTION

The systems and techniques described here relate to software for organizations in a restructuring environment, such as a merger and acquisition (M&A) environment. In particular, the software described provides tools and interfaces for restructuring members during a restructuring process.

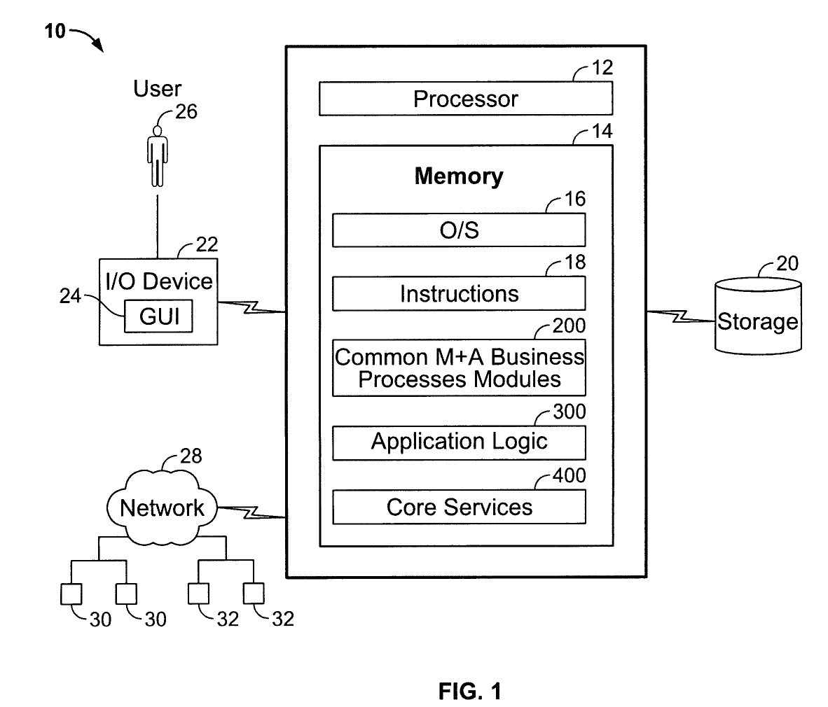

As shown in FIG. 1, a system 10 includes a processor 12 and a memory 14. Memory 14 includes an operating system 16, and instructions 18, that when executed by the processor 12, perform an exemplary restructuring integration process 100, described below. A specific restructuring process, referred to as a merger and acquisition (M&A), will be used as an example throughout this description. However, the process 100 can be applied to most corporate change or restructuring activities, such as spin-offs, department mergers and splits, and so forth. Memory 14 also includes common restructuring business processes modules 200, application logic 300, and a core framework of services 400 that support the restructuring integration process 100. The system 10 includes a link to a storage device 20 and an input/output device 22. The input/output device 22 can include a graphical user interface (GUI) 24 for display to a user 26.

The system 10 includes a link to a network 28. Network 28 links the system 10 to other systems 30 within a single entity and to systems 32 in one or more other entities. Systems 30, 32, generally referred to as clients or source systems, access data through a portal 34. Systems 10, 30, 32 are designed to act as a single logical physically distributed information system representing multiple enterprise information systems of organizations residing in the systems 30, 32. Information is exchanged between the system 10 and systems 30, 32 through the portal 34 and through user interfaces (UIs) of architecture, described below.

As used herein, the terms “electronic document” and “document” mean a set of electronic data, including both electronic data stored in a file and electronic data received over a network. An electronic document does not necessarily correspond to a file. A document can be stored in a portion of a file that holds other documents, in a single file dedicated to the document in question, or in a set of coordinated files.

The term “organization” refers to a company, enterprise, business, government, educational institution, or the like. The term “organization” can also refer to a group of persons, such as an association or society. An “enterprise change” or “organization change” refers to a merger, an acquisition, a combination of a merger and acquisition or some other type of change in an organization's structure, leadership, governance, personnel, business, direction, purpose, strategy, etc.

A “synergy” can be a value, performance or effect that can be achieved as resources of two organizations combined will be greater than the sum of the separate individual resources. The term “synergy” can also refer to cooperative interaction among groups, especially among the acquired subsidiaries or merged parts of an organization, which creates an enhanced combined effect. For example, if a first organization has a superior product and inferior distribution, and a second company has an inferior product and superior distribution, then the organizations can create synergy with a merger.

The term “object” refers to information sources such as documents, reports, presentations, files and directories. A “template” is an interface that can include parameters or a format from a previous merger, or can be transferred or copied from another employee in the same organization or a customer. “Stakeholders” are exemplary merger members described herein with an interest or stake in the progress of the restructuring, or persons who are involved in some aspect of the restructuring or its effects.

A “deliverable” can be referred to as a “task” that one or more stakeholders are responsible for producing for other stakeholders. A deliverable can be referred to as a goal, objective, result or procedure that can be fulfilled, promised, achieved, produced or expected.

Due diligence can involve investigation and examination into one or more details of a potential investment, such as an examination of operations and management and a verification of material facts.

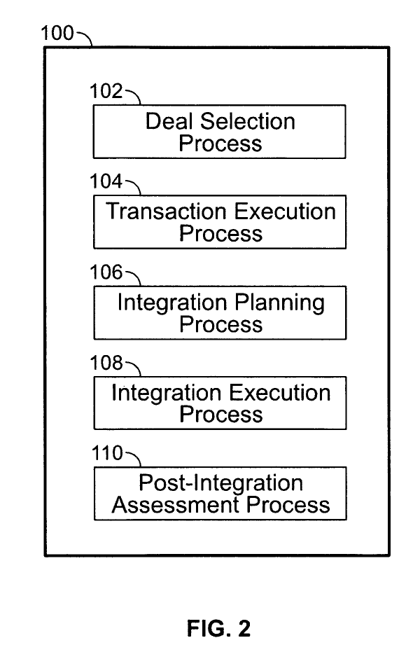

As shown in FIG. 2, the restructuring integration process 100 includes a deal selection process 102. The deal selection process 102 defines acquisition objectives and strategies. The deal selection process 102 searches for the best fit target company to meet a set of objectives and manages detailed due diligence on the target company. The deal selection process 102 also identifies synergies, risks and a realization plan for acquiring the target company.

A transaction execution process 104 structures an acquisition in terms of type, tax implications, legal issues and so forth. The transaction execution process 104 closes an acquisition deal and provides for a rollback in the event the acquisition deal fails.

An integration planning process 106 provides a plan for short term and long term tasks of acquisition integration and communicates goals and decisions to all stakeholders.

The restructuring integration process 100 includes an integration execution process 108. The integration execution process 108 manages an integration project and it sub-projects, designs a new organization, and minimizes disruptions to customers by rolling out combined field organizations quickly.

The integration execution process 108 manages the integration of information technology (IT), human resources (HR), financials and procurement. The integration execution process 108 provides for the retention of key employees, manages field organization integration, and identifies cross-selling opportunities and rolls the opportunities out. The integration execution process 108 manages stakeholders, tracks an acquisition, and reports issues and successes.

The restructuring integration process 100 includes a post-integration assessment process 110. The post-integration assessment process 110 measures achieved synergies against targets, accesses where improvements can be made in synergy estimation and/or in integration execution, and applies history to a next transaction.

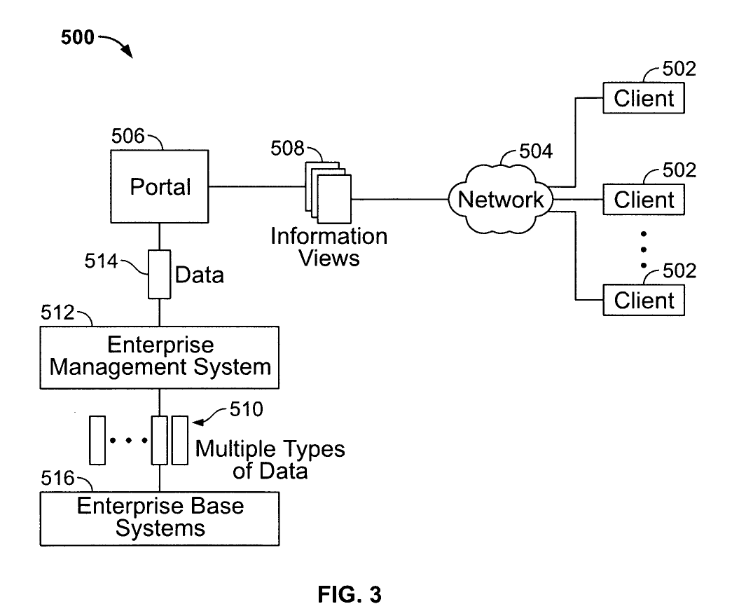

As shown in FIG. 3, the restructuring integration process 100, common restructuring business processes modules 200, application logic 300, and core framework of services 400 are designed to conform to architecture 500 designed to a platform 600 that represents a single logical physically distributed information system representing multiple enterprise information systems of organizations. The architecture 500/platform 600 insure consistency of data exchange between system 10 and source systems 30, 32, and a separation of source systems 30, 32, when appropriate during phases of the restructuring integration process 100.

The single logical physically distributed information system architecture 500 representing multiple enterprise information systems of organizations includes multiple clients 502 accessing data over a network 504 through a portal 506. In one embodiment, the clients 502 are processes and/or web browsers that are coupled to the network 504 through a proxy server (not shown).

The portal 506 provides a common interface to program management services through user interface (UI) components 508.

The portal 506 receives requests from the clients 502 and generates information views (iViews) 510, such as web pages, in response. In embodiments, the portal 506 implements a user roles-based system to personalize a common interface and the iViews 510 for a user of one of the clients 502. The user can have one or more associated roles that allow personalized tailoring of a presented interface through the iViews 510.

The portal 506 communicates with an enterprise management system 512 that consolidates multiple application services.

The portal 506 receives data 514 from the system 512 to fulfill the requests of the clients 502. The system 512 provides integrated application services to manage business objects and processes in a business enterprise. The business objects and processes include resources such as personnel, development projects, business programs, inventories, clients, accounts, business products, business services and so forth.

The system 512 communicates with enterprise base systems 516 to obtain multiple types of enterprise base system data 518. The base systems 516 include application services, such as human resource management systems, customer relationship management services, financial management systems, project management systems, knowledge management systems, business warehouse systems, time management systems, electronic file systems and mail systems. In embodiments, the enterprise base systems 516 include a single integration tool, such as exchange from SAP AG of Germany, which provides an additional level of integration among the enterprise base systems 516. The enterprise management system 512 consolidates and integrates data and functionality of the enterprise base systems 516 into the single management tool.

The single management tool includes systems and methods to facilitate generation of new applications within the enterprise management system 512. The new applications, generally referred to as cross-functional or composite applications, draw on resources of the enterprise base systems 516 to cross over traditional application boundaries and handle new business scenarios in a flexible and dynamic manner.

A virtual business cycle can be generated using such composite applications, where executive level business strategy can feed management level operational planning, which in turn can feed employee level execution, which can feed management level evaluation, which can feed executive level enterprise strategy. Information generated in each of these stages in an enterprise management cycle can be consolidated and presented by the enterprise management system 512 using the customized cross-functional applications. The stages provide and consume determined services that are integrated across multiple disparate platforms.

The portal 506, enterprise management system 512 and enterprise base systems 516 can reside on one or more programmable machines, which communicate over the network 504 or one or more communication busses. In embodiments, the base systems 516 reside in multiple servers connected to the network 504, and the portal 506 and enterprise management system 512 reside in a server connected to a public network (not shown). Thus, the architecture 500 can include customized, web-based, cross-functional applications, and a user can access and manage enterprise programs and resources using these customized web-based, cross-functional applications from anywhere that access to the public network is available.

A user interface (UI) provides UI patterns used to link new objects and workflow together and generate standardized views into results generated by one or more cross-functional applications.

An object modeling tool enables generation of new business objects in a persistency/repository layer by providing a mechanism to extend a data object model dynamically according to the needs of an enterprise.

A process modeling tool enables generation of new business workflow and ad hoc collaborative workflow. The process modeling tool includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure is trackable by a process owner or by involved contributors using a “dashboard” that displays highly aggregated data. The dashboard and a “myOngoingWork place” can be two UI patterns that are provided by the UI components 508.

Whenever there is a concept of “myObjects,” “myRecentObjects,” “myRelatedObjects” or “myPreferredObjects,” then an object picker UI pattern, provided by the UI components 508, is included that lets users pick their favorite object directly. Whenever people are to be searched, either for choosing one individual person or for generating a collection of people meeting some criterion, a “People Finder” concept can be applied. A key aspect of searching for a person is described as an attribute within the user's activity, qualification, interest, and collaboration profile. For a given cross-functional application, people collections can be stored as personal or shared collections using the People Finder to make them available for further operations later on.

Whenever there is a strategic view on a cross-functional application scenario, analytics of the overall portfolio can be made available in the form of a collection of the UI components 508. A view selector is used to display/hide components, and a component can be toggled between graphical and numerical display and include a drop-down list or menu to select sub-categories or different views.

Cross-functional application scenarios provide related information to the user when possible, and some parts within a larger cross-functional application define what kind of related information is to be offered. Heuristics can be used to identify such relatedness, such as follows: (1) information that is related to the user due to explicit collaborative relationships, such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set); (5) instances of the same object class; (6) next abstract or next detailed class; (7) explicit relationships on the organizational or project structure; (8) proximity on the time scale; (9) information about the underlying business context; and/or (10) information about the people involved in a collaborative process.

Cross-functional applications also can include generic functionality in the form of “Control Center Pages” that represent generic personal resources for each user. These cross-functional applications can refer to the following pages, where appropriate: (1) A “MyOngoingWork” page that provides instant access to all dashboards that let users track their ongoing work. Ongoing work refers to the state of business objects as well as guided procedures. (2) A “MyDay” page that lists today's time based events that are assigned or related to the user. (3) “MyMessageCenter” page that displays all pushed messages and work triggers using a universal inbox paradigm with user selected categorical filters. (4) “MyInfo” that provides access to all personal information collections (documents, business objects, contacts) including those located in shared folders of teams and communities of which the user is a member. MyInfo can also provide targeted search in collaborative information spaces such as team rooms, department home pages, project resource pages, community sites, and/or personal guru pages.

The object modeling tool, process modeling tool and user interfaces are used to build components of cross-functional applications to implement new enterprise management functions without requiring detail coding development by a system architect or programmer.

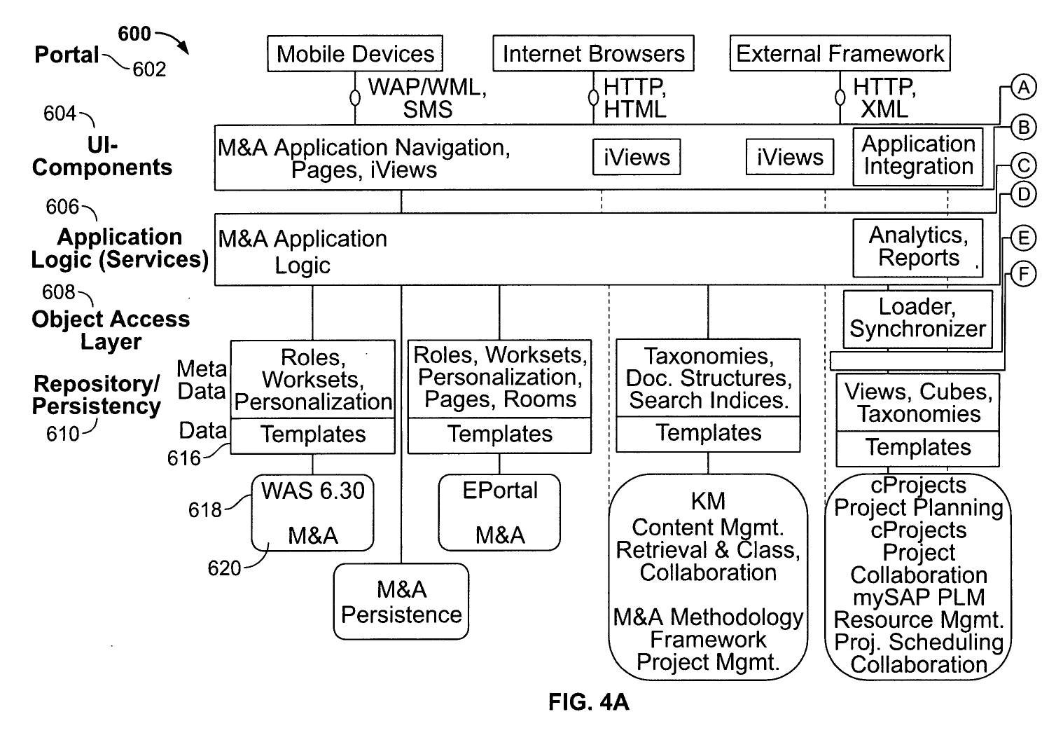

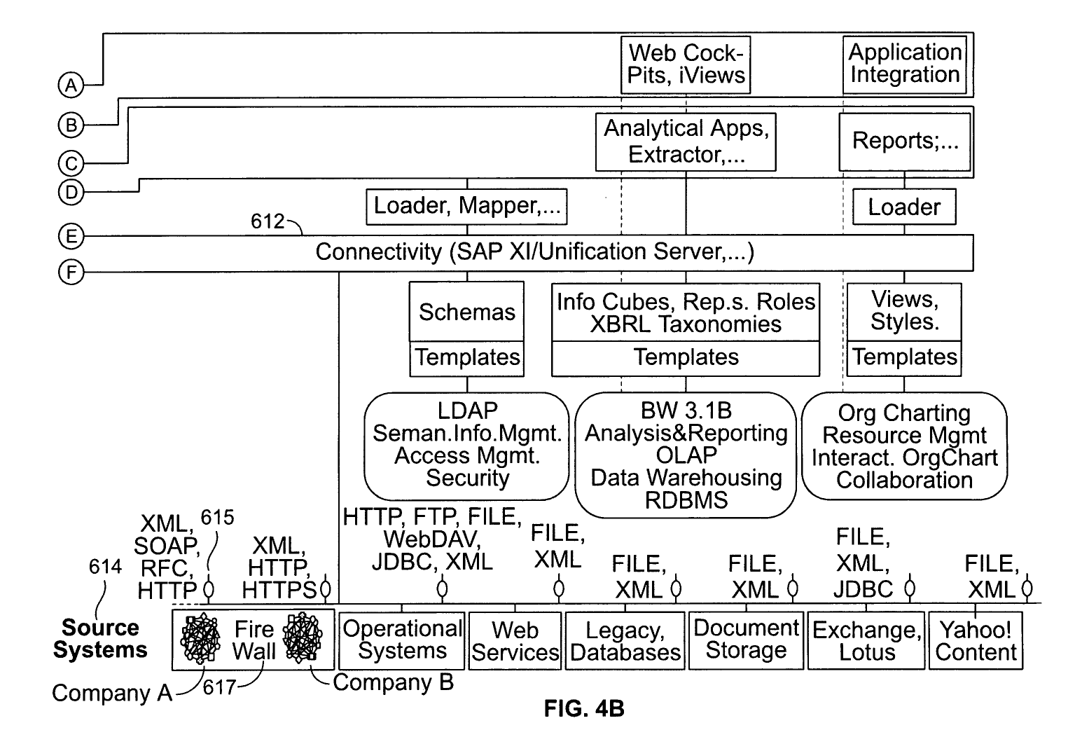

As shown in FIG. 4, a platform 600 that supports the architecture 500 includes a portal 602, user interface (UI) components 604 and application services logic 606. The platform 600 includes an object access layer 608, a persistence/repository layer 610, connectivity layer 612, and source systems 614. In embodiments, the architecture includes software and components from SAP AG of Germany, as well as special corporate restructuring modules.

Graphical user interfaces (GUIs) provide interaction between a user and the UI components 604 through the portal 602. The UI components 604 interact with the application services logic 606. The application services logic 606 interact with databases and repositories in the persistence/repository layer 610. The user requests information via a GUI through the portal 602. The application services logic 606 processes the user request, retrieves the appropriate requested information from the databases and repositories in the persistence/repository layer 610, and sends the requested information to GUI for display to the user.

The databases and repositories in the persistence/repository layer 610 can contain metadata. Metadata refers to data that describes other data, such as data pertaining to roles, work sets and personalization information, for example. The metadata can interact with the object access layer 608, connectivity layer 612 and application services logic 606. The metadata can also interact with templates 616. The templates 616 provide a format or organization of information according to preset conditions. The templates 616 can interface with Web application server (WAS) processes 618 and core merger processes 620 in the repository layer 610.

In embodiments, the databases and repositories in the persistence/repository layer 610 interact with the source systems 614 through base system connectors 615 using a markup language such as extensible markup language (XML), web services such as Simple Object Access Protocol (SOAP), request for comments (RPC), or Transmission Control Protocol/Internet Protocol (TCP/IP). The source systems of one organization can interact with the source systems of another organization through a firewall 617.

The base system connectors 615 can include an enterprise connector (BC) interface, Internet communication manager/Internet communications framework (ICM/ICF), an encapsulated postscript (EPS) interface and/or other interfaces that provide remote function call (RFC) capability.

The persistence/repository layer 610 provides the platform 600 with its own database and data object model. The database and data object model provides a consolidated knowledge base to support multiple enterprise functions, including functions generated as cross-applications. Active communication between the persistence/repository layer 610 and the base systems 516/614 provides a linkage between real time relational data from multiple base systems 516/614 and an integrated enterprise tool to permit strategic enterprise management and planning.

The data object model represents a subset of data objects managed by base systems 516/614. Not all of the data aspects tracked in the base systems 516/614 need to be recorded in the data object model. The data object model has defined relationships with data objects stored in the base systems 516/614. For example, certain data objects in the data object model have “read-only” or “write-only” relationships with data objects in the base systems 516/614. These types of defined relationships are enforced through a communication process between the persistence/ repository layer 610 and the base systems 516/614. The persistence/repository layer 610 decouples application development from the underlying base systems 516/614.

In embodiments, the source systems 516/614 interact with third party applications, such as Lotus software from IBM or data provided by other content providers, such as Yahoo!

As described above, the portal 602 provides a common interface to management services. The management services include a merger project management service and a merger integration project management service. The network 504 links the clients 502 to the portal 602 for exchange of information pertaining to a merger of two organization organizations or an acquisition involving two organizations.

By way of example, an exemplary merger process is described herein. However, the methods and systems described herein apply generally to most corporate restructurings, such as spin-offs, department mergers and splits, and so forth.

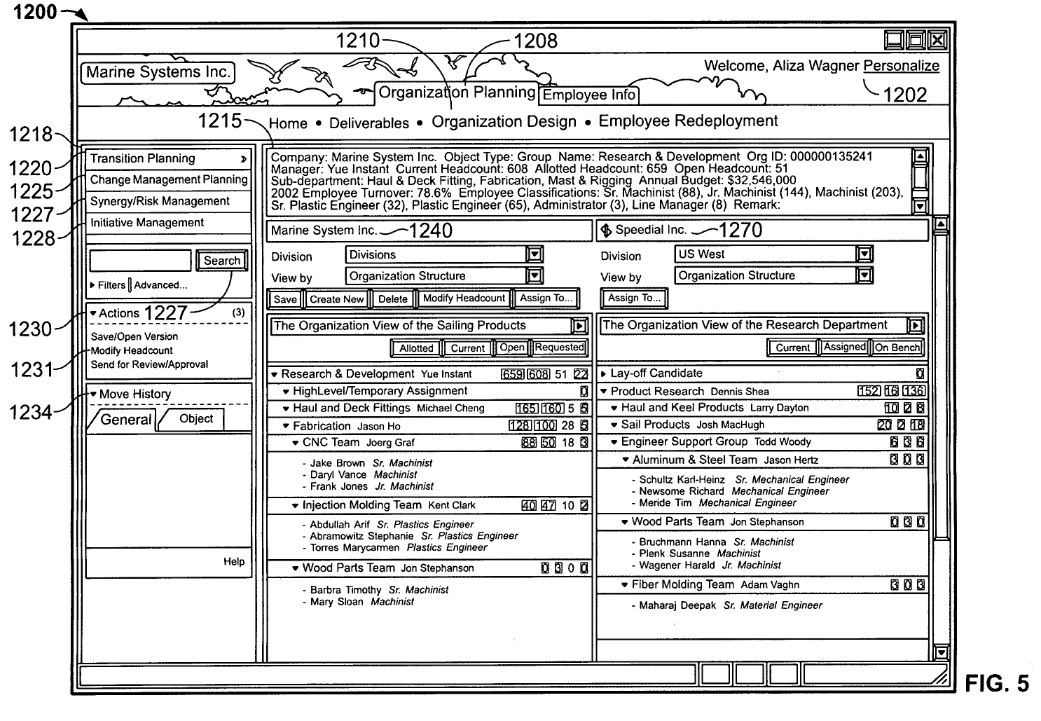

FIG. 5 illustrates an exemplary organizational design tool interface 1200. The interface 1200 is selected by a stakeholder 1202 from the organizational planning menu 1208. The interface 1200 includes a panel 1240 for an acquiring organization, such as Marine Systems Inc., and a panel 1270 for an acquired organization, such as Speedial Inc. The organizational design interface 1200 is used for stakeholder members involved with strategic organizational design and transition planning. Interface 200 facilitates the management of organizational design in the post-closing 1106.

A “fact sheet” panel 1215 displays organizational information, such as a financial statement, an organizational historical or background statement, investor information, and answers to frequently asked questions (FAQs). The “fact sheet” panel 1215 also displays one or more details for a particular stakeholder group, employee headcount, headcount types, previous headcount transitions, and predicted headcount transitions.

Another panel 1218 in the interface 1200 permits the stakeholder 1202 to navigate among a display of various interface views, such as a transition planning view 1220, a change management planning view 1225, a synergy/risk management view 1227, and an initiative management view 1228. The stakeholder 1202 can enter a search query 1229, and perform other actions 1230 related to organizational planning 1208, such as modifying headcount 1231. Additionally, the panel 1218 allows the stakeholder to access a history 1234 of other stakeholder and group movements during a merger.

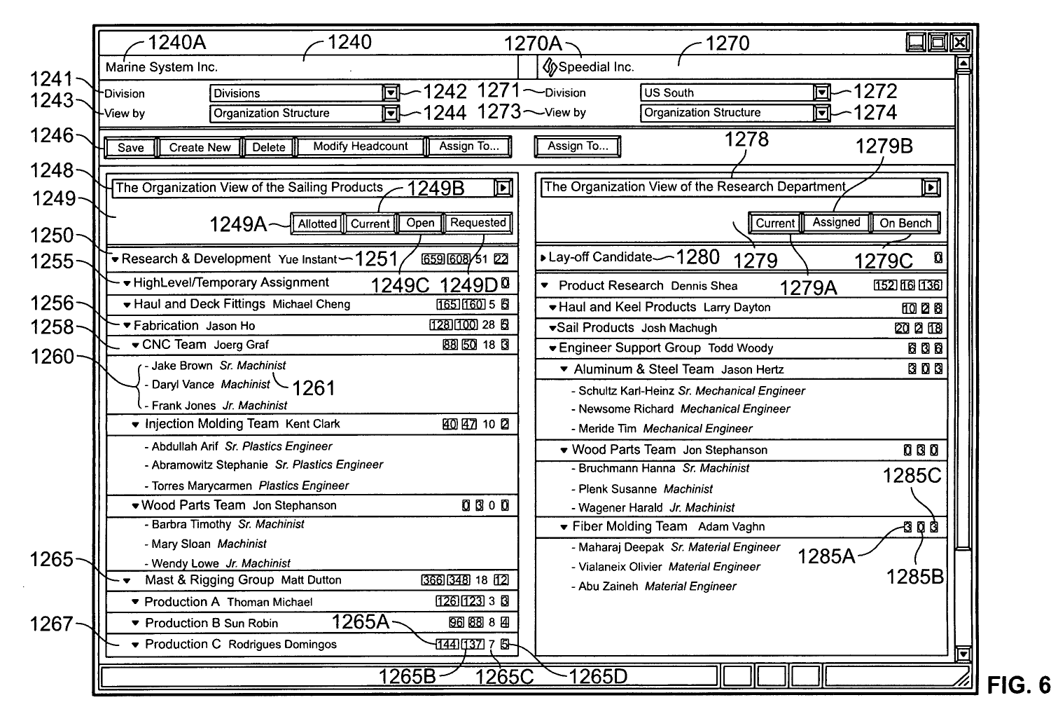

FIG. 6 illustrates a panel 1240 for the acquiring organization, and a panel 1270 for an acquired organization. The panels 1240 and 1270 enhance organizational design efforts when planning new headcounts, shifting headcounts, or tracking transition changes. Additionally, the panels 1240 and 1270 assist in employee reassignments by searching and matching resources, and tracking the status of employee movements. Since other organizational planning stakeholders can view and edit the interface 1200 and the panels 1240 and 1270, collaborative employee assignment and management of redeployments are supported.

The panel 1240 presents a view 1248 of the acquiring organization 1240A. A stakeholder 1202 can elect a division 1241 of the organization 1240A with a selector 1242. The selector 1242 can open a pull-down menu of options such as divisions, offices, function or status. The stakeholder 1202 also can select a view 1243 with another selector 1244. The selector 1244 opens a pull-down menu of viewable options such as organizational structure, job function, and grade. Furthermore, the panel 1240 presents other options 1246 to the stakeholder 1202 including saving a profile, generating a new profile, deleting a profile, modifying organizational headcount, or making an assignment to another stakeholder of one or more organizations.

The organizational view 1248 of the Sailing Products displays a hierarchy of departments such as research and development 1250 and fabrication 1256. The panel 1240 identifies a lead stakeholder 1251 of each department, and a group 1260 of stakeholders, including an organizational title 1261 for each stakeholder group member. The status of a number 1249 of positions are displayed for each division, group or subgroup. For example, the Production C subgroup 1267 in the Mast and Rigging Group 1265 presents a number 1265A of allotted positions 1249A, a number 1265B of current positions 1249B, a number 1265C of open positions 1249C, and a number 1265D of requested positions 1249D. The panel 1240 shows the status of transitional stakeholders or stakeholders with temporary assignments 1255.

Panel 1270 presents an organizational view 1278 of a research department of an acquired organization 1270A, Speedial Inc. In panel 1270, a stakeholder 1202 can elect a division 1271 of the organization 1270A with a selector 1272. However, the selector 1272 can open a different pull-down menu than the selector 1242 of panel 1240. For instance, the selector 1272 can open a pull-down menu of options displaying regional organizational divisions such as US South, US East, US West, and US Central.

As in panel 1240, panel 1270 presents information to display the status of a number of positions for each stakeholder division or group. For instance, panel 1270 shows that the Fiber Molding Team 1290 has a number 1285A of current positions 1279A, a number 1285B of assigned positions 1279B, and a number 1285C of undetermined positions 1279C. The panel 1270 may even display layoff candidates 1280.

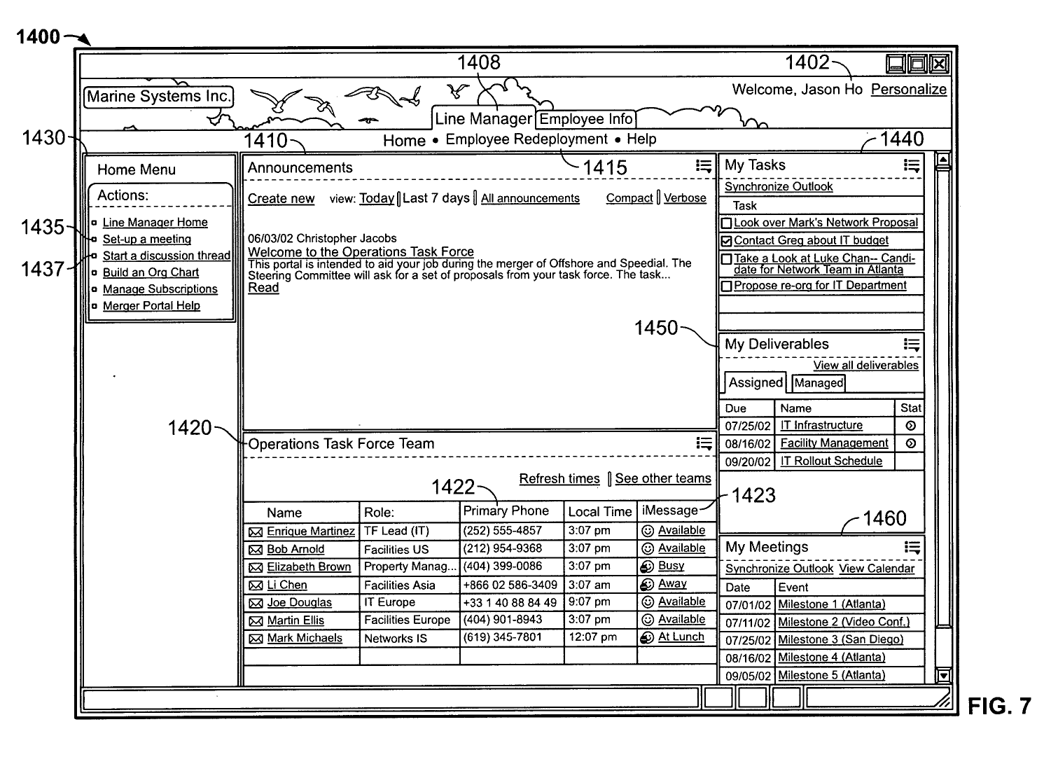

FIG. 7 illustrates an exemplary tool interface 1400 for a stakeholder 1402 (e.g., a line manager). The interface 1400 can be personalized 1402 for the stakeholder 1402 and greet the stakeholder 1402 with an announcement panel 1410. The stakeholder 1402 can view a panel 1420 of the operations task force team, along with the contact information 1422 and availability 1423 of team members.

The interface 1400 allows the stakeholder 1400 to collaborate with other stakeholders to conduct organizational design tasks such as arranging a meeting 1435 or starting a discussion thread 1437 with panel 1430. The interface 1400 has personalized panels for tasks 1440, deliverables 1450, and meetings 1460. Each panel 1440, 1450, 1460 can have selectable hypertext link functions.

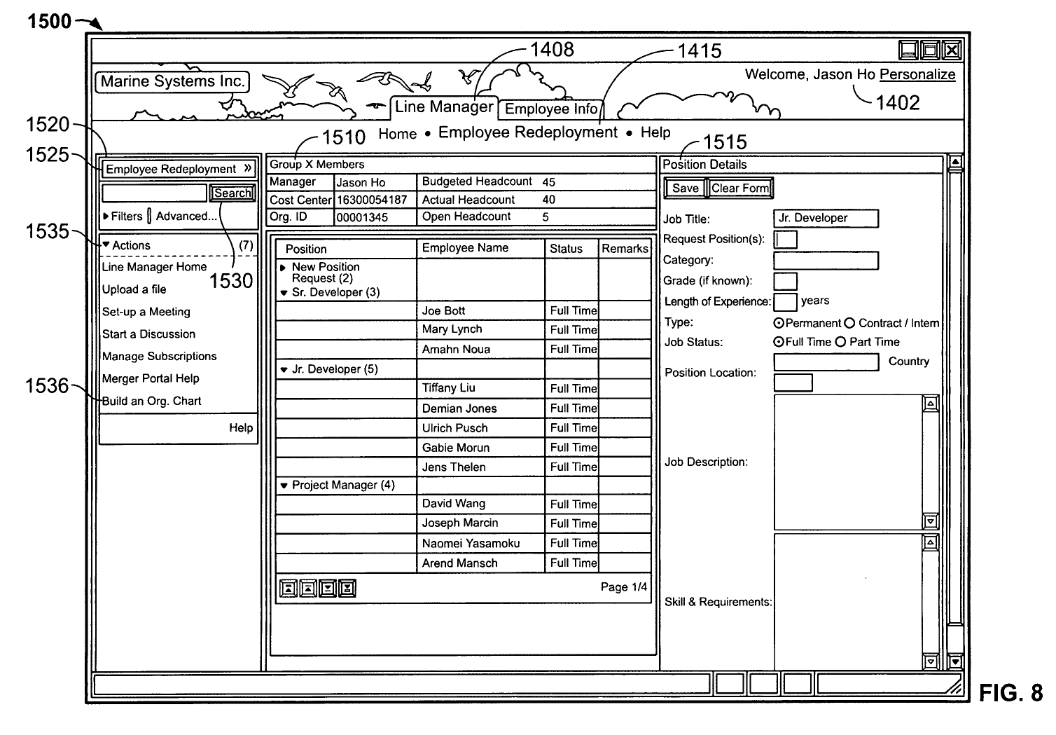

FIG. 8 illustrates an employee redeployment interface 1500 for the stakeholder 1402. For this interface 1500, an employee redeployment indicator 1415 is selected. The interface 1500 shows a panel 1510 for a group of stakeholders, a panel 1515 for positional details, and a panel 1520 with other navigational abilities for the stakeholder 1402. In panel 1520, the stakeholder 1402 accesses an employee redeployment navigation indicator 1525, a search query interface 1530, and other stakeholder actions 1535, such as building an organizational chart.

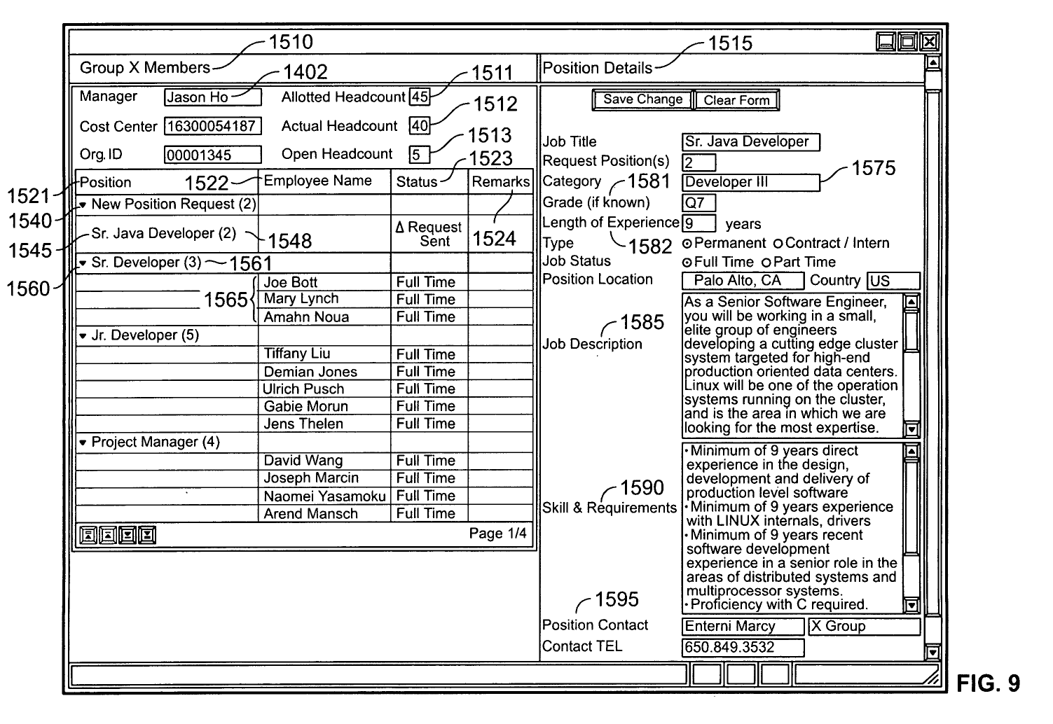

FIG. 9 presents panel 1510 and panel 1515 from interface 1500, in which panel 1515 has completed information fields, such as field 1575. In panel 1510, the stakeholder 1402 can examine an allotted headcount value 1511, an actual headcount value 1512, and a value 1513 of open headcounts. The stakeholder 1402 can inspect a status 1523 for organizational positions 1521 with accompanying descriptions and remarks 1524. The stakeholder can access the positions in an organization by the title 1560 of the position, and view a number 1561 of stakeholders 1565 listed under a particular position.

Panel 1510 presents new position requests 1540, and the types 1545 and numbers 1548 of the new position requests 1540. A position request type 1545 is detailed in panel 1515 with completed fields, such as a job description 1585, and skills and requirements 1590. A positional grade level 1581 and length of experience 1582 also may be displayed in panel 1515. The position detail panel 1515 can associate a position with a contact stakeholder 595.

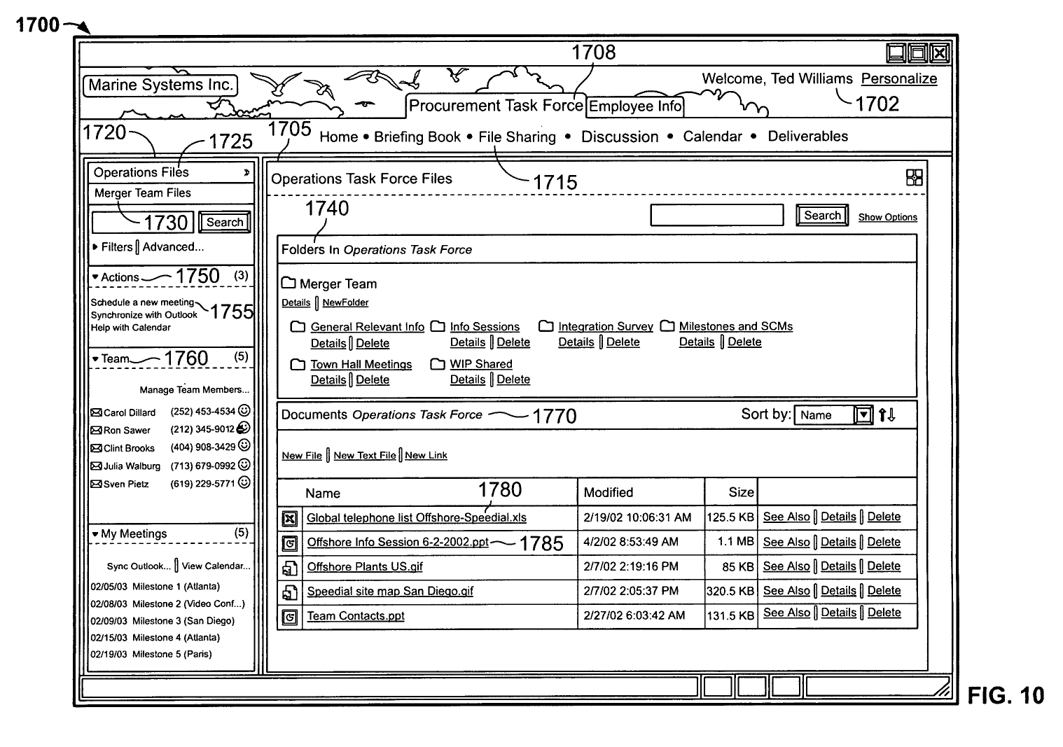

FIG. 10 illustrates an interface 1700 that allows stakeholders from various groups to collaborate and share information during the merger. In particular, the interface 1700 show stakeholder 1702 in the procurement task force. The procurement task force tab 1708 presents the stakeholder 1702 with a menu of views, including a view 1715 for sharing objects with other stakeholders in the procurement task force. The view 1715 presents a panel 1735 for the stakeholders in the procurement task force to share folders 1740 and documents 1770 with stakeholders in the operations task force.

The shared objects can be external objects. Examples of these externally-generated objects include an Excel spreadsheet 1780, or a PowerPoint presentation 1785.

The stakeholder 1702 in the procurement task force can also share objects with stakeholders in a merger team 1730. Additionally, the stakeholder 1702 can view and access other procurement task force team members 1760 and initiate merger actions 1750, such as scheduling a new meeting 1755.

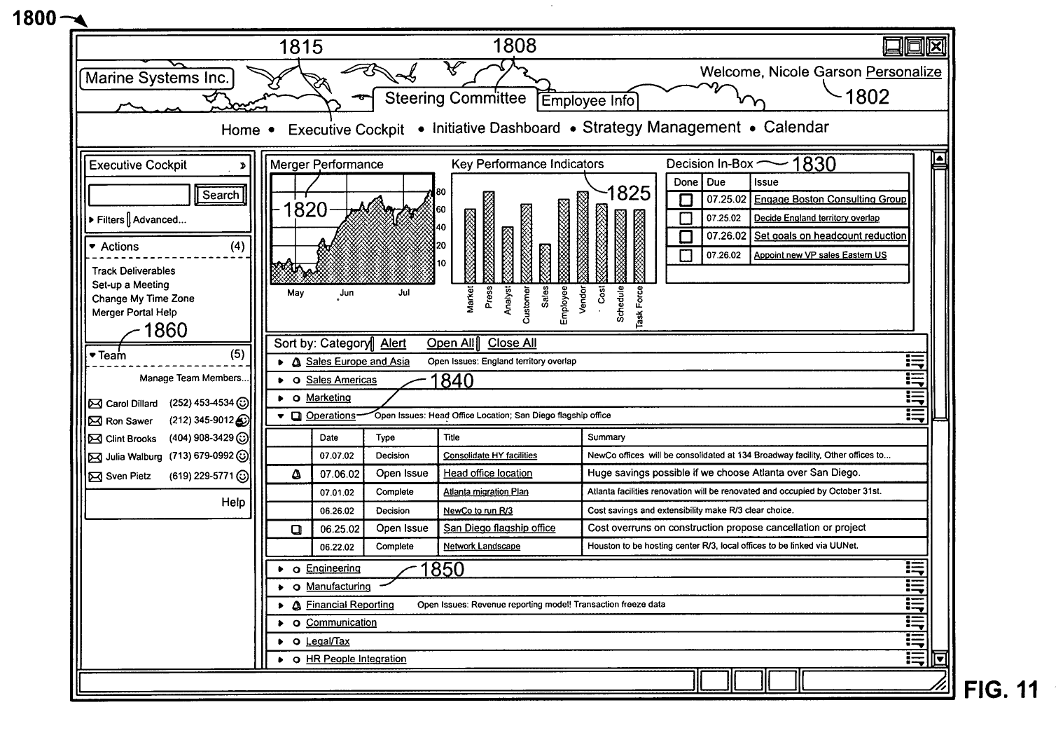

FIG. 11 illustrates a tool interface 1800 for a stakeholder 1802 in a merger steering committee. The steering committee can have an interface tab 1808 that presents a menu of views, including the presented view of an “executive cockpit” 1815. The executive cockpit 1815 is also referred to as a “Control Center” page or dashboard. The executive cockpit view 1815 allows executive board stakeholders 1145 to access, plan, and manage various aspects of the merger. Interface 1800 can chart the merger performance 1820 and present key performance indicators 1825. The interface 1800 presents merger issues in a decision box 1830. Merger issues can be presented by type or category. For example, the stakeholder 1802 can view issues in a manufacturing division 1850 or in an operations department 1840. The interface 1800 also allows the stakeholder 1802 to contact and manage other stakeholders 1860.

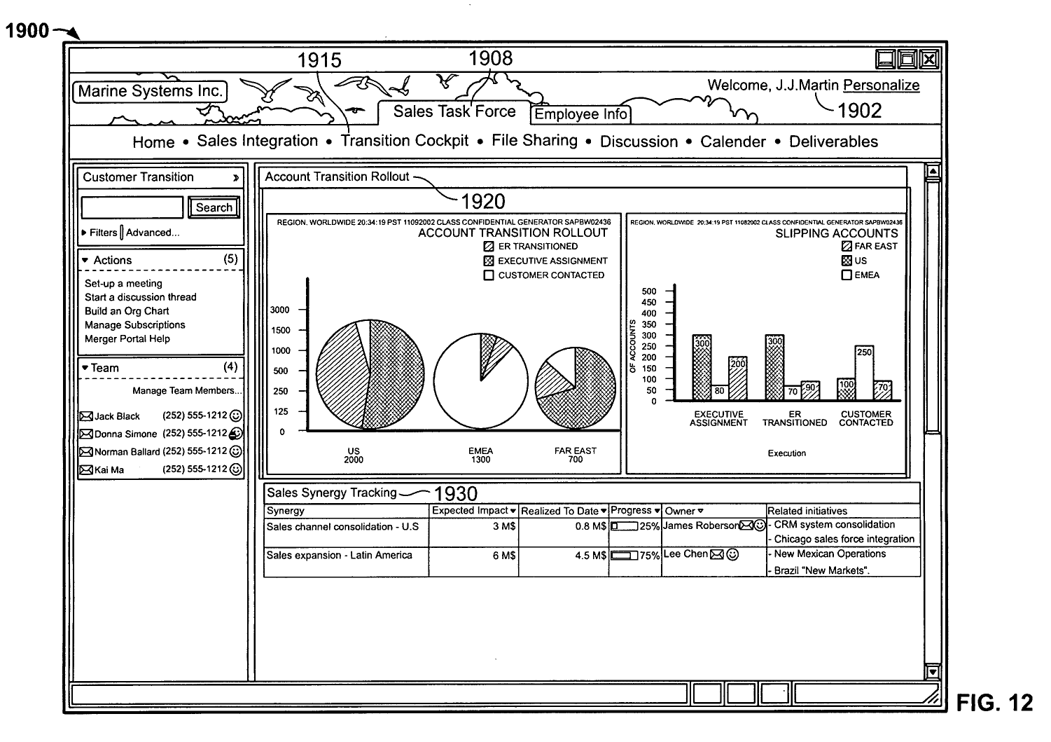

A tool or module can be included to identify and track supplier 1185 and customer 1175 stakeholders during the merger process. FIG. 12 shows an example of a tool interface 1900 for a stakeholder 1902 with access to a sales task force menu 1908. Other possible views for stakeholders in the sales task force interface 1900 include views for sales integration, file sharing, discussions, deliverables, and a calendar. The view presented in interface 1900 is a transition cockpit view 1915. The view 1915 allows the stakeholder 1902 to access and manage sales-related transition tools for the merger, including an account transition rollout 1920, and sales synergy tracking 1930.

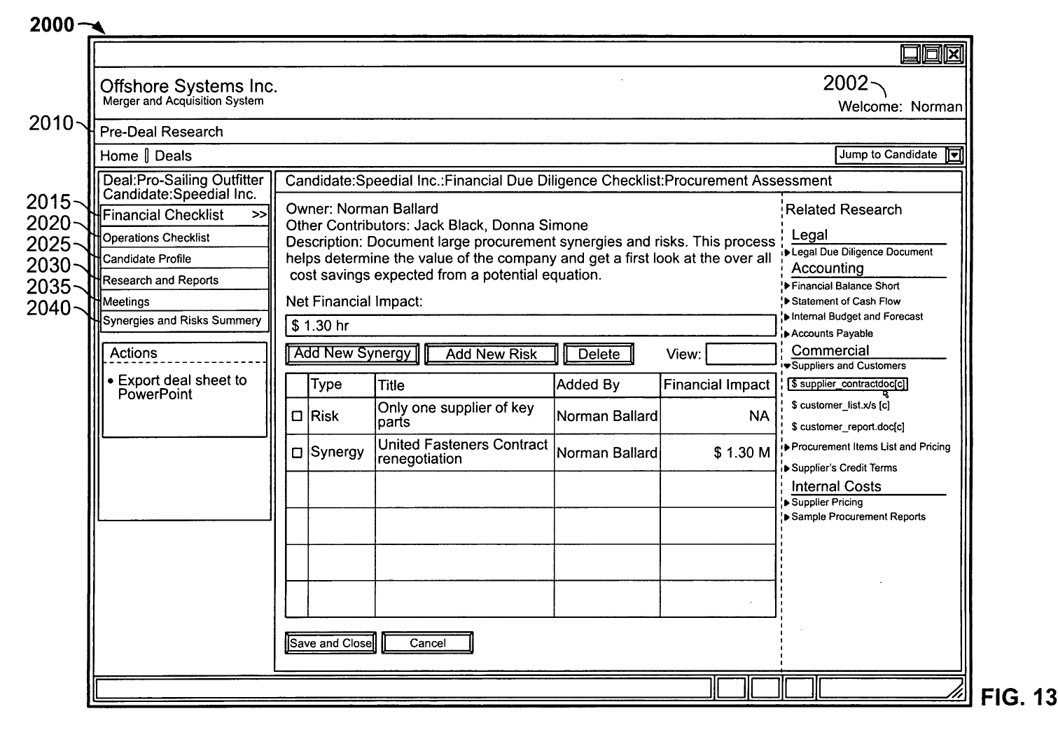

FIG. 13 shows a tool interface 2000 to allow a stakeholder 2002 to access, plan, and manage pre-deal research 2010. The stakeholder 2002 accesses views in a financial checklist 2015, an operations checklist 2020, a profile of a targeted merger candidate 2025, and other research and reports 2030. The stakeholder 2002 schedules a meeting 2035 and view organizational synergies and risk summaries 2040.

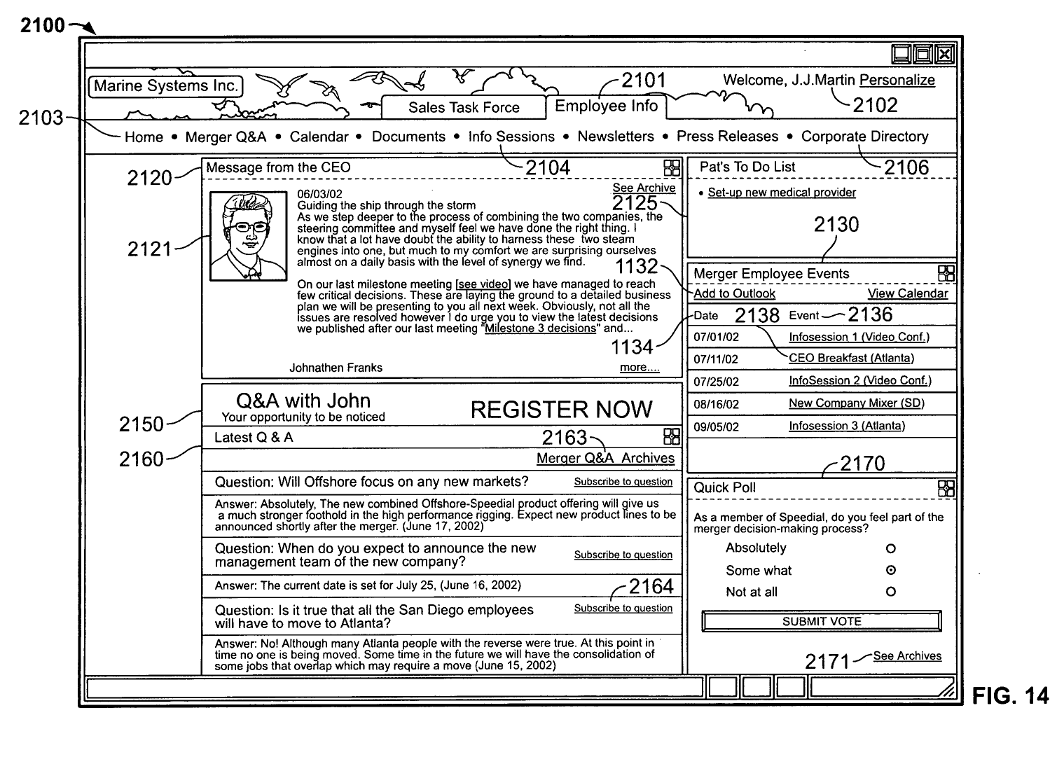

FIG. 14 illustrates an employee information interface 1400. An executive stakeholder of an organization, such as a chief executive officer (CEO) 2121, can update employee stakeholders on the progress of the merger, as illustrated in panel 2120. The employee stakeholder 2102 can also interact with the CEO 2121 with panels 2150 and 2160. Panel 2160 presents a question and answer (Q&A) session that allows employee stakeholders to submit questions or statements to the CEO 2121. The CEO 2121 communicates with the employee stakeholder 2102, and other employee stakeholders can view the communications and join the interactive discussion 2164. Such interaction allows a merger organization to retain employee stakeholders, and reduces the amount of misinformation that arises during a merger.

Panel 2125 allows the stakeholder 2102 to have a personalized merger task list. Panel 2170 allows employee stakeholders to submit and view interactive polls or questionnaires. Employee stakeholders also view previous polls 2171 and Q&A sessions 2163 that have been archived.

Panel 2130 keeps employee stakeholders informed of merger-related events. For example, panel 2130 displays the date 2134 and type of event 2136 related to a merger, such as a CEO breakfast event 2138 in Atlanta. The employee stakeholder 2102 selects the event link of 2138 and can be presented with a page (not shown) of information related to the breakfast. The employee stakeholder can add the event to an external calendar program, such as the calendar program in Outlook® from Microsoft Corporation. The employee stakeholder 2102 can access other merger interfaces, such as a corporate directory 2106, an informational session 2104, or a personalized home page 2103.

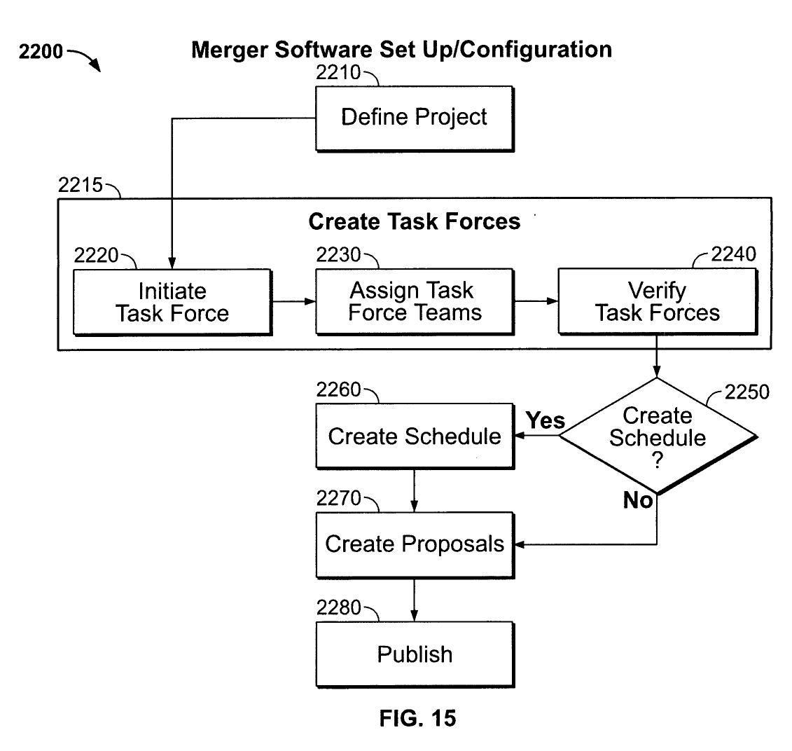

FIG. 15 depicts a flowchart 2200 of an exemplary stakeholder set up.

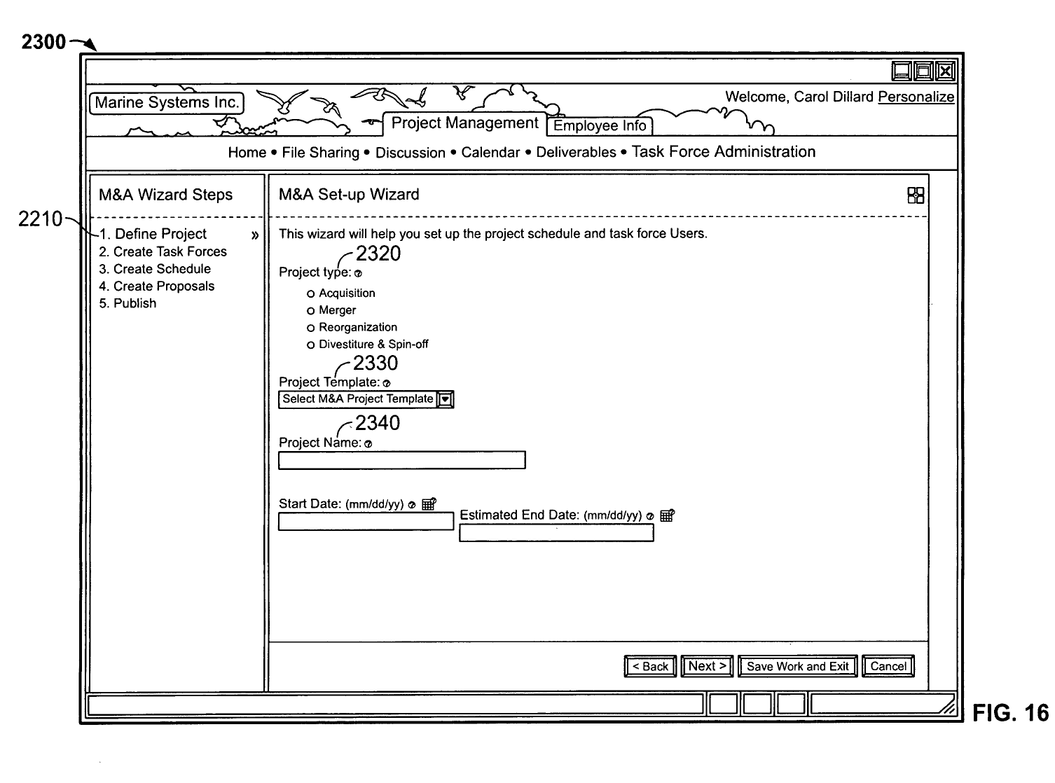

The user is allowed to define the project 2210, as illustrated in FIG. 16. The interface 2300 in FIG. 16 defines a project by type 2320 or a predefined project template 2330. Additionally, a project name 2340 can be entered in the interface 2300.

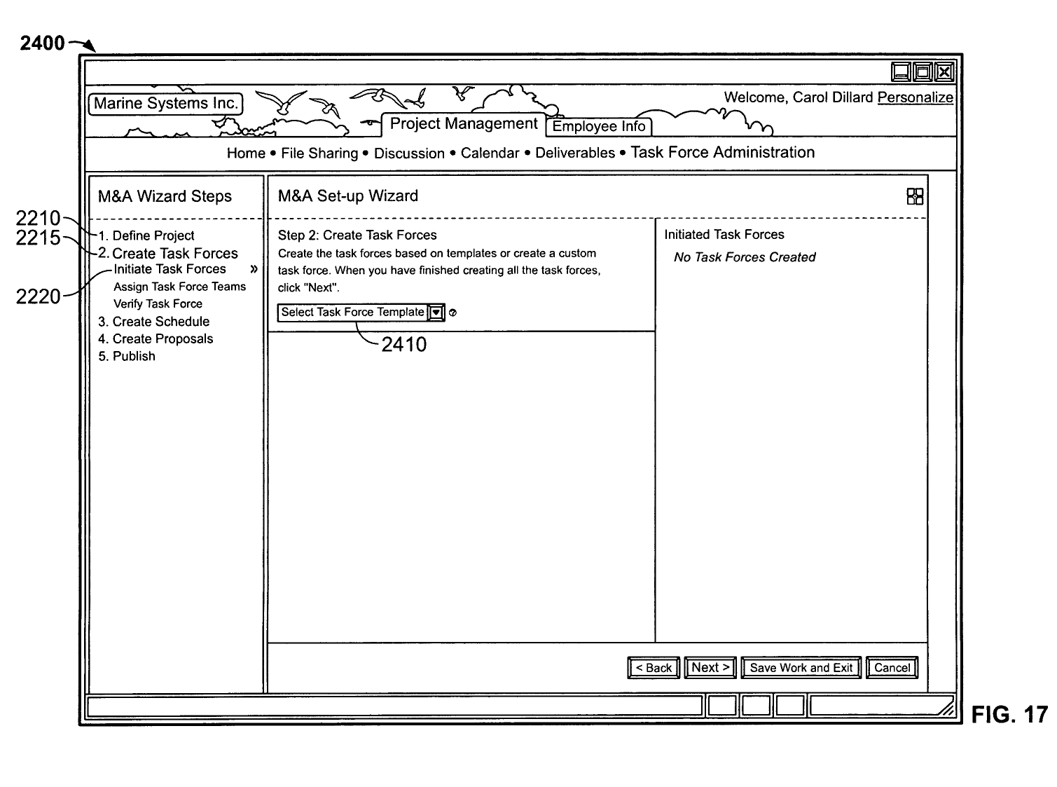

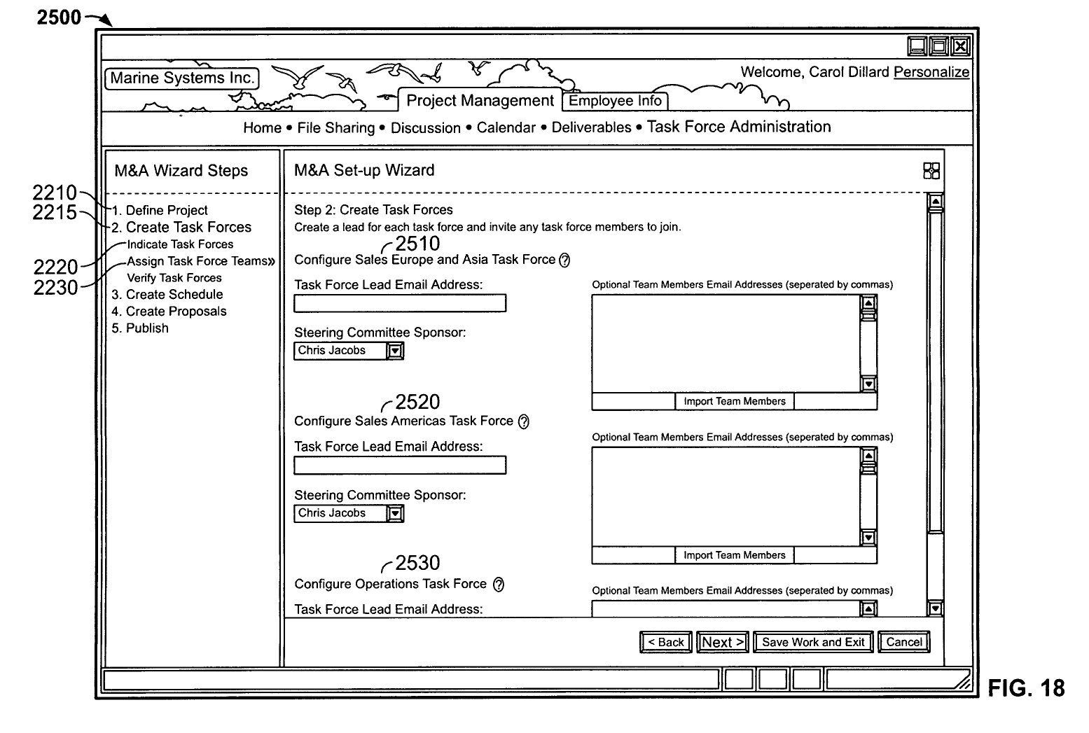

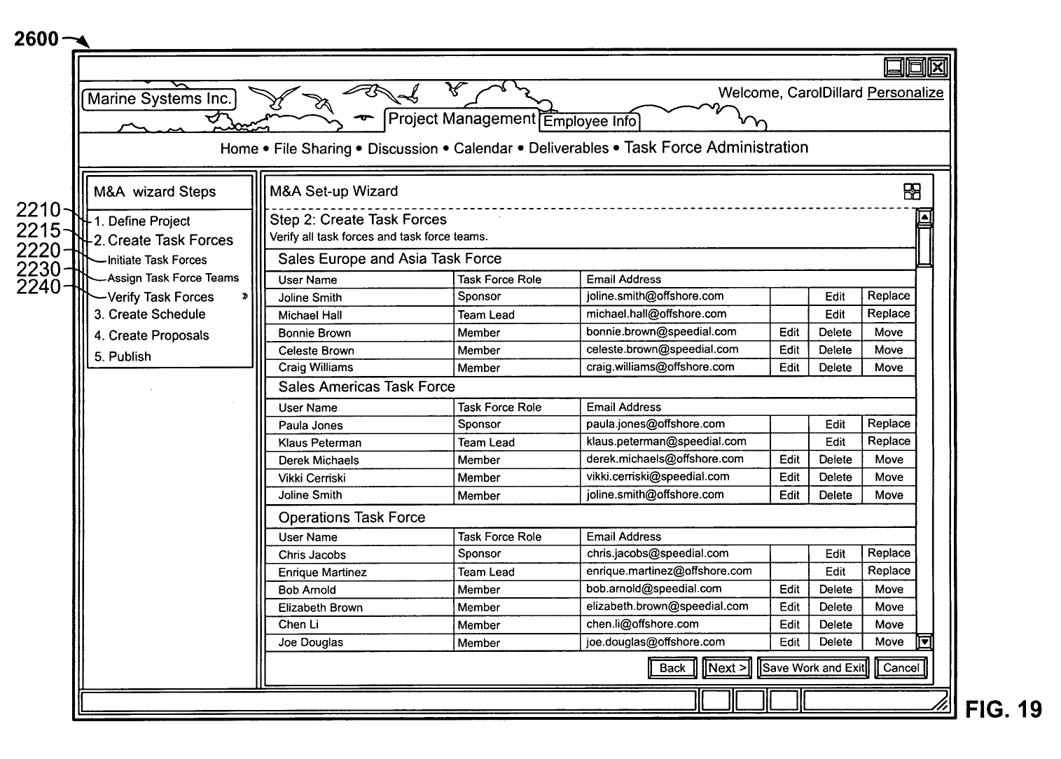

The user is allowed to generate, add and edit merger task forces 2215. A task force can be initiated 2220 with a template, as shown 2410 in FIG. 17. The tool 2200 allows the user to assign stakeholders to task force teams 2230. As illustrated in FIG. 18, stakeholders can be assigned to one or more sales teams 2510 and 2520. Moreover, other task force teams, such as the operations task force 2530, can be arranged or configured in the user interface 2500. After the members of the task force teams have been assigned, the task force team assignments can be verified 2240. FIG. 19 illustrates an interface 2600 to verify task forces.

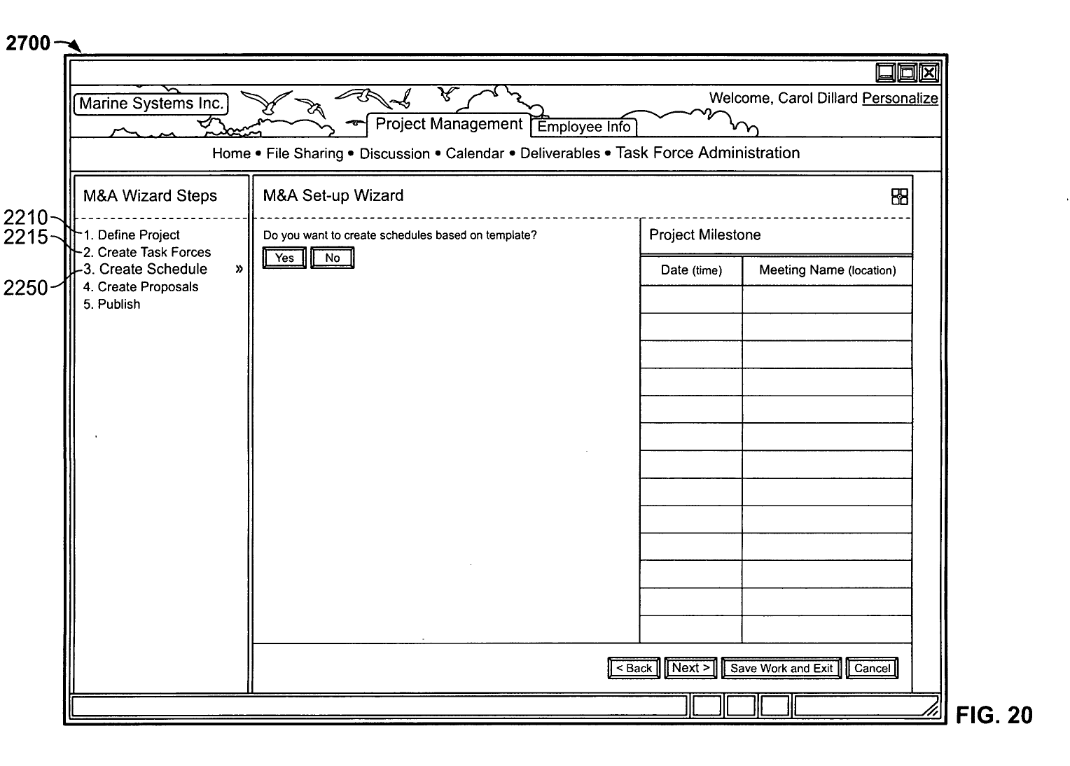

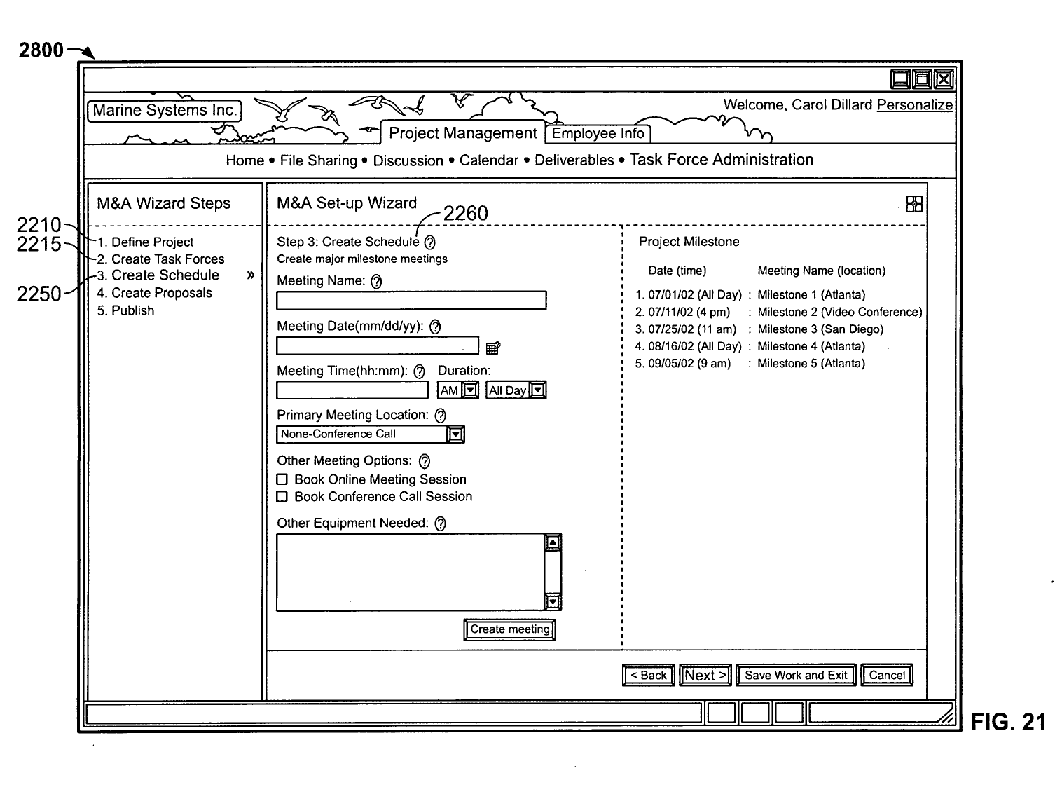

A user can generate a schedule 2250 as shown in interface 2700 in FIG. 20. A generated schedule is illustrated in interface 2800 in FIG. 21. If the schedule is not generated, then proposals 2270 can be created. Otherwise, if a schedule is generated as shown in 2800, then proposals are created for the next configuration block 2270.

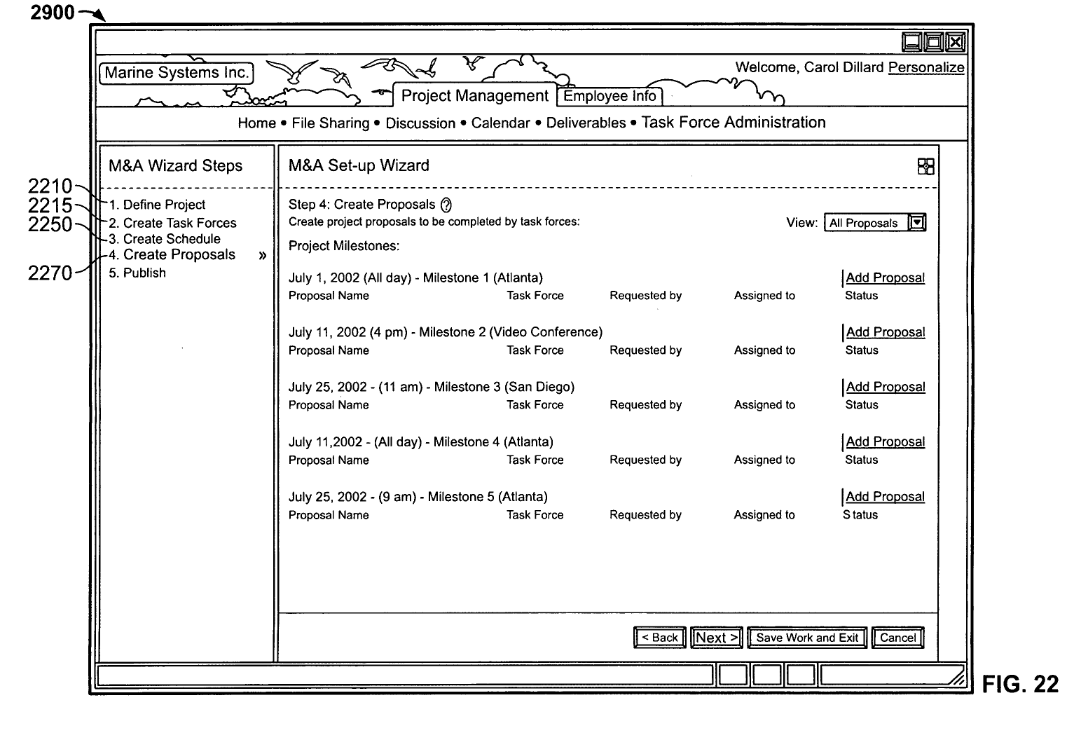

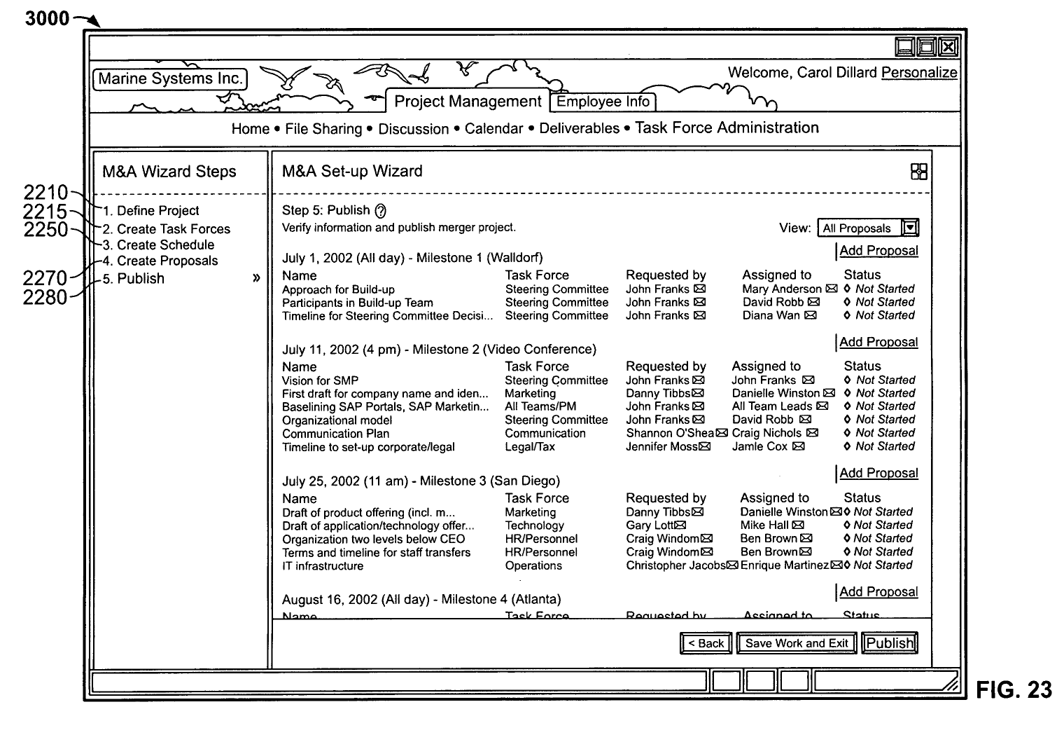

An exemplary proposal interface 2900 is shown in FIG. 22. After one or more proposals are generated, then the merger project information can be published 2280 as illustrated in interface 3000 in FIG. 23.

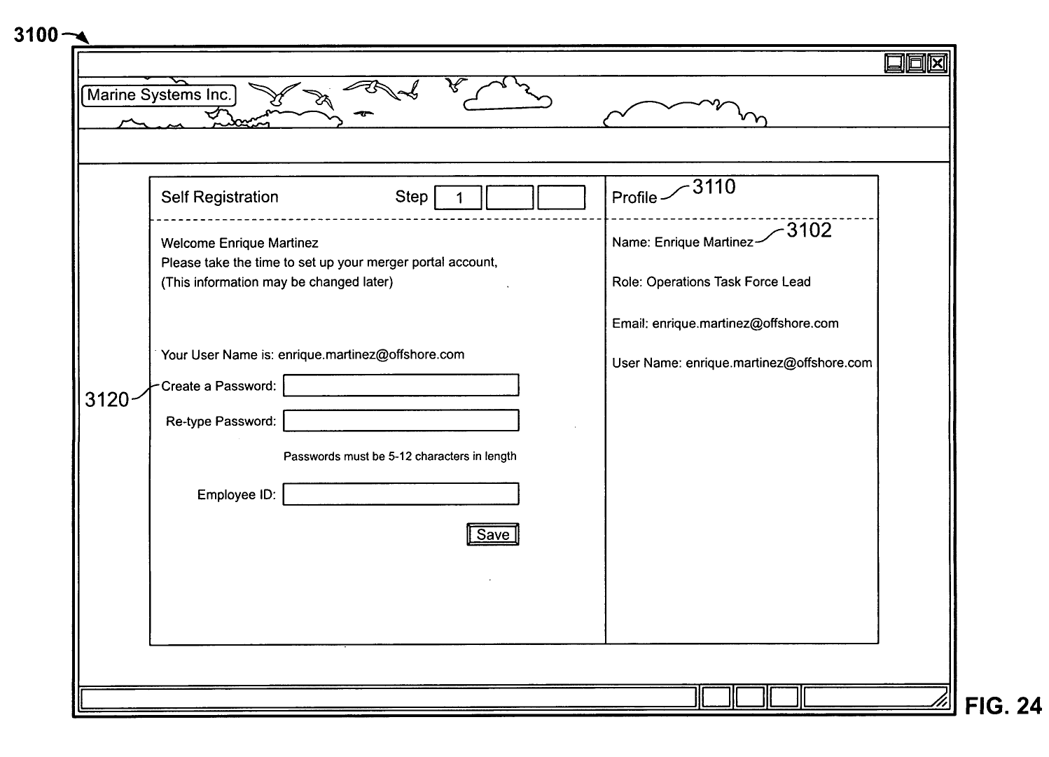

FIG. 24 illustrates an interface 3100 that allows a stakeholder 3102 to self register and create a profile 3110. The interface can require a password 3120 from the stakeholder 3102.

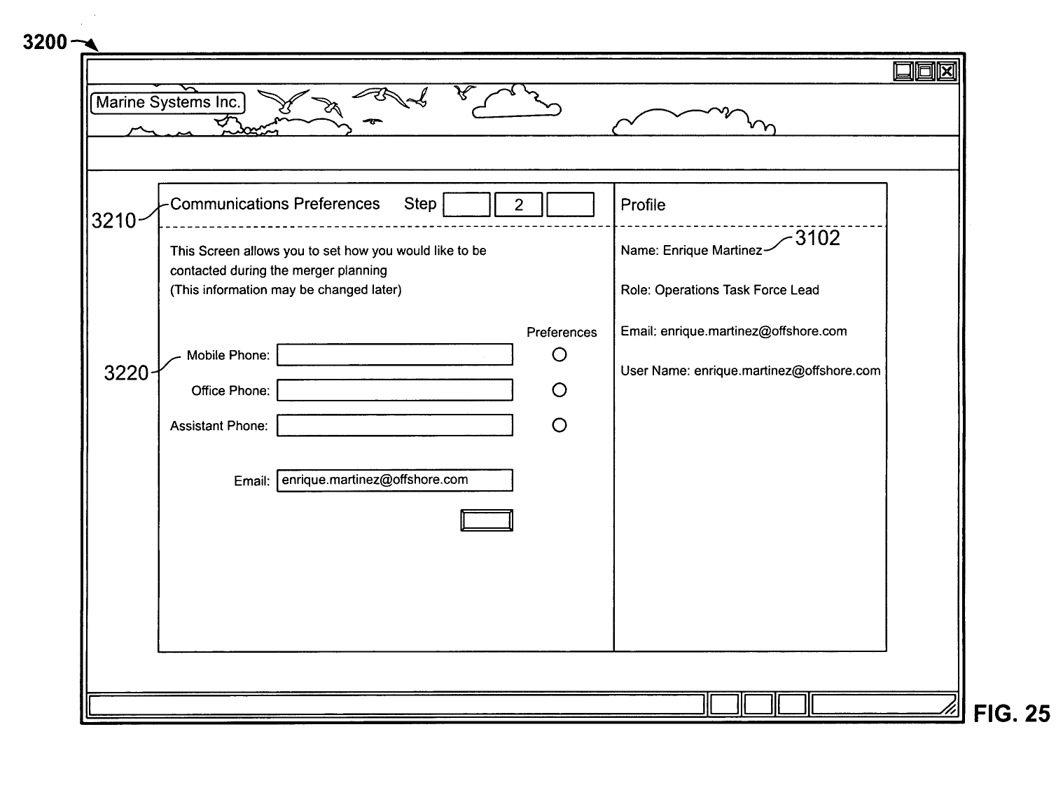

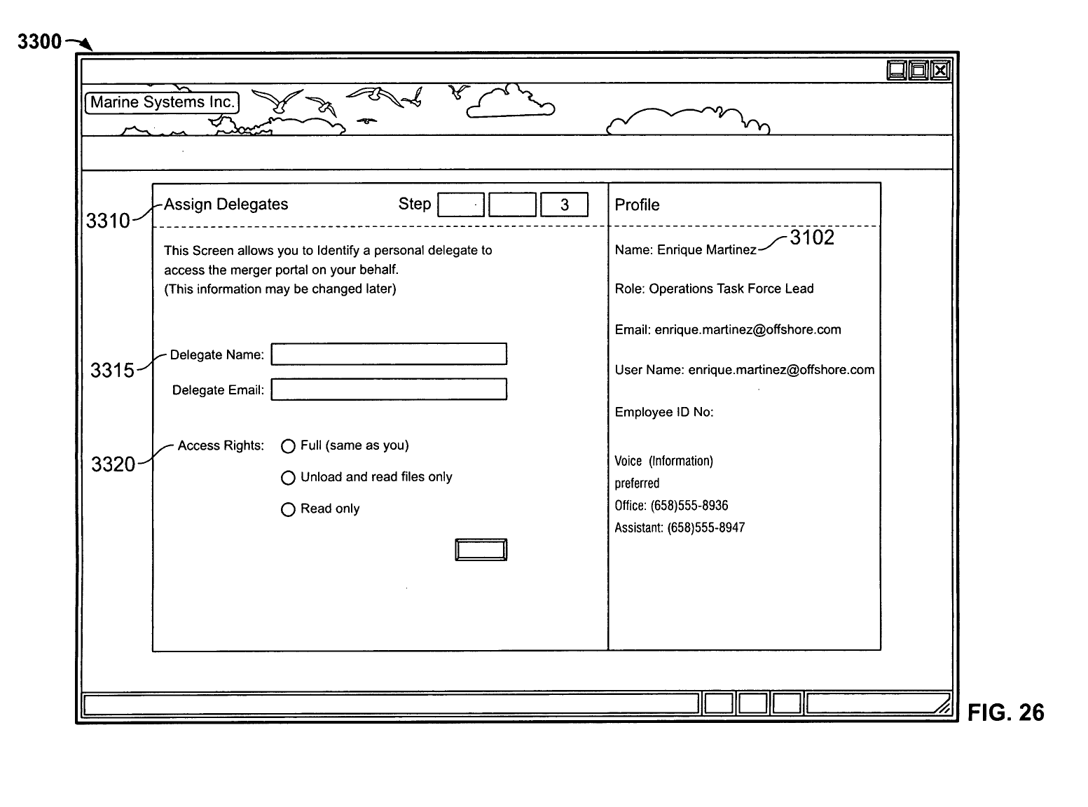

After the stakeholder 3102 initiates a profile in interface 3100, communication preferences 3210 from the stakeholder 3102, as shown in interface 3200 FIG. 25. In FIG. 26, an interface 3300 prompts the stakeholder 3102 user to identify a personal delegate 3315 to access the merger portal on behalf of the stakeholder 3102. The delegate 3315 can have full or partial access rights 3320 to the portal for the stakeholder 3102.

Other embodiments may be within the scope of the following claims.

What is claimed is:

1. A method of facilitating an enterprise change, the method comprising:
treating two or more information systems as a single logical information system to execute pre-change due diligence and post-change integration of the enterprise change, the enterprise change being at least one of a merger and acquisition; and
providing a user interface to allow a user to conduct a merger activity.

2. The method of claim 1 wherein the user interface is adapted to allow a stakeholder plan and manage the merger activity, the user interface further adapted to allow a user to access one or more merger resources.

3. A method comprising:
providing a single logical physically distributed information system across one or more information systems of at least two enterprises that are being combined; and
providing a user interface to access the single logical physically distributed information system, wherein the single logical physically distributed information system executes one or more pre-merger activities, merger activities, and post-merger activities.

4. The method of claim 3, wherein the user interface is adapted to at least one of a role of the user and a phase of the merger, wherein the user role comprises an internal expert and an external expert of one of the enterprises, wherein the internal expert comprises at least one of an executive, an employee, a manager, an investor, and an owner of one of the enterprises, wherein the external expert comprises at least one of a consultant and an auditor.

5. The method of claim 3, wherein the role of the user further comprises a stakeholder affected with one or more merger closing consequences, wherein the one or more merger activities comprise an organizational restructuring, a personnel redeployment, a merger project management, a procurement management, a personnel retainment, and an integration of operational services.

6. A system for planning a restructuring of at least two organizations, the system comprising:
an intranet interface adapted for at least one employee of one of the organizations; and
an extranet interface adapted for an external restructuring member of at least one of the organizations; and
an information repository related to at least one of the organizations, the information repository being accessible by the intranet interface.

7. The system of claim 6, wherein the extranet interface comprises a password interface, wherein the system further comprises a firewall between the intranet interface and extranet interface.

8. A system for implementing a restructuring of at least two organizations, wherein the system comprises an object modeling tool, a repository, a template, and an interface for a user to edit information for one or more personnel of at least one of the organizations.

9. The system of claim 8, wherein the repository comprises metadata.

10. A system for implementing a restructuring of at least two organizations, the system comprising:
a tool adapted to track one or more stakeholders;
a module adapted to identify one or more stakeholders; and
a tool interface adapted to allow a stakeholder to access, plan, and manage pre-deal research.

11. The computer system of claim 10, further comprising a user interface adapted to allow collaboration with the one or more stakeholders, the collaboration comprising an arrangement of a meeting and an initiation of a discussion thread.

12. A system for implementing a merger of at least two organizations, the system comprising a stakeholder interface, the stakeholder interface comprising:
a first panel adapted to allow a user to navigate among a user interfaces related to the merger;
a second panel displaying one or more members of one or more groups of the organizations; and
a search query interface adapted to allow a user to search for information related to the merger.

13. The system of claim 12, further comprising a menu adapted to receive a user selection, wherein the stakeholder interface is adapted to allow an interactive discussion among merger members.

14. The system of claim 13, wherein the stakeholder interface further comprises a menu for disparate interfaces, the disparate interfaces comprising a communication interface, an information sessions interface, and an organizational directory, the stakeholder interface further comprising a personalized merger task interface, a merger event interface, and an interface to a calendar.

15. The system of claim 14, wherein the system further comprises one or more tools presenting a stakeholder with at least any one of a personalized object, a preferred object, a recently accessed object, and a merger-related object.

16. A system comprising:
a layer of merger application logic services for the merger of at least two organizations;
information repositories for the merger; and
user interfaces adapted to retrieve information from the information repositories, the user interfaces adapted to interact with the layer of merger application logic services.

17. A system for planning a merger of at least two organizations, the system comprising an intranet template adapted for at least one stakeholder of at least one of the organizations.

18. The system of claim 17, wherein the intranet template comprises a reference model, the reference model comprising objects, folders, security settings, and reports.

19. A system adapted to execute management actions for a merger of at least two organizations, the system comprising a user-selectable portfolio of organizational information for planning, reporting, and analyzing merger information on a graphical user interface.

20. The system of claim 19, further comprising a definition tool, wherein the definition tool is an integrated system tool.

21. A computer system adapted to execute actions for a merger of at least two organizations, the actions comprising:
registering a stakeholder of the merger; and
initiating a profile for the stakeholder.

22. The computer system of claim 21, wherein the actions further comprise allowing a personal delegate to access a merger interface on behalf of the stakeholder, wherein the registering a stakeholder of the merger comprises providing access to a user of a user interface, wherein the providing access comprises requesting a password from the user.

23. The computer system of claim 22, wherein the merger interface is adapted to grant at least partial access rights to the personal delegate.
